(19) United States
(12) Patent Application Publication
(10) Pub. No.: US 2010/0187372 A1
(43) Pub. Date: Jul. 29, 2010

(54) Monitor support apparatus

(76) Inventor: Andrei Smirnov, Morgantown, WV (US)

Correspondence Address: STEPTOE & JOHNSON, CHASE TOWER, 6TH FLOOR, P.O. BOX 2190, CLARKSBURG, WV, 26302-2190, US

(21) Appl. No.: 12/312,938

(22) PCT Filed: Mar. 28, 2007
(86) PCT No.: PCT/US2007/065298

§ 371 Date: Jun. 1, 2009

Related U.S. Application Data
(60) Provisional application No. 60/856,827, filed on Nov. 6, 2006.
(60) Provisional application No. 60/883,772, filed on Jan. 5, 2007.
(60) Provisional application No. 60/886,947, filed on Jan. 28, 2007.

(51) Int. Cl. A47C 7/62; F16M 13/02; F16M 11/04

(52) U.S. Cl. 248/118; 248/205.1; 248/121; 248/125.8

(57) ABSTRACT

Interacting with a computer is usually done in a sitting position, which can be harmful to people's health. The invention provides a possibility to use reclining furniture, providing dorsal or ventral support or both, with large angles of inclination, including lying down postures facing up or down, while performing work with the computer. The application uses a specially designed mechanical arm holding the monitor which can be used in a combinations with a couch or a sofa to provide a direct view of the monitor from a variety of postures allowed by the article of furniture. Special means such as pivots and telescopic joints are used to adjust a position and orientation of the monitor. The application can be used for viewing both computer and TV monitors.

### 1 SUMMARY

This application describes an apparatus which facilitates viewing a computer monitor while assuming a variety of postures with strongly inclined body orientations when it is no longer convenient to use conventionally mounted monitors. In particular, it consists of a mechanical arm supporting a monitor (Claim 1), which in combination with two body support devices, including a rotating arms rest (Claim 17) and upper body support apparatus (Claim 18) enables one to position the monitor in front of the face while sitting, reclining back or forward, as well as lying down, all in resting postures, when the body is provided with appropriate supports, so that the muscles of the torso and the neck are completely relaxed. The embodiments for the apparatus considered include a monitor arm attached to the couch, and a monitor stand detached from the couch and resting on the floor.

### 2 DESIGN ELEMENTS

26. Pivot axis for the backrest mounted axial arm.27. Arm pivot joining the monitor arm to the top of the backrest.28. Arm mounted on the side of backrest

30. Axis of rotation for 28

32. Horizontal pivot mounted on the side of the backrest

33. Telescopic adjustment to position the monitor horizontally above the couch

34. A vertical axis with a telescopic adjustment to position the monitor 2 above the couch

35. Base frame of a dual support chair

36. Horizontal pivot for rotating the base-mounted arm in a vertical plane

37. Main horizontal support arm

38. Vertical pivot for rotating base-mounted arm in a horizontal plane

39. Second horizontal support arm

40. Support member for a monitor stand

42. Forehead support cushion

44. Carriage and rails assembly

46. Horizontal pivot for rotating armrest in a vertical plane

48. Vertical pivot for rotating armrest in a horizontal plan

50. Head support of the ventral support stand

52. Pivot joint for the head support

54. Upper frame of the ventral support stand

56. Upper chest support

58. Telescopic joints for length adjustment of the ventral support stand

60. Elbow and arms support for the ventral support stand

62. Desk panel for holding keyboard, mouse, etc.

64. Telescopic height adjustments

66. Base support of a ventral support stand

### 3 DESCRIPTION

The novelty of this invention is that it enables comfortable positioning of the monitor in front of person's face for a variety of reclined postures when the inclination of the head changes considerably between the postures, while the relative positioning between the head and the monitor remains the same. This functionality can be realized when several conditions are fulfilled, such as: (1) the monitor should be placed at about arms lengths from the body, (2) the screen of the monitor should be oriented parallel to the coronal plane of the head, (3) this positioning of the monitor should be possible for at least two different inclinations of human head, which differ by a predetermined minimum angle.

The article of furniture appropriate to use with the apparatus, which we shall call a couch for brevity, can be a reclining chair or a couch, or a sofa, reclining or not, or a similar item of furniture, which can recline at a large angle, or provide the possibility for lying horizontally, as well as specific items of furniture providing an additional possibility for leaning forward using ventral support.

The essential part of the proposed apparatus is a mechanical arm (Claim 1) capable satisfying the above criteria. In particular this arm can hold a monitor in a position appropriate for both a reclining or a laying-down postures of a human body with either dorsal or ventral support, when it is impossible to achieve comfortable positioning of a conventionally mounted monitor. The dorsal support can be provided by a reclining backrest of a chair, or a horizontal seat area of a conventional sofa when used for laying down. The means of head support which can be used in this case can be either a head support member mounted on the backrest, a neck cushion, or similar items.

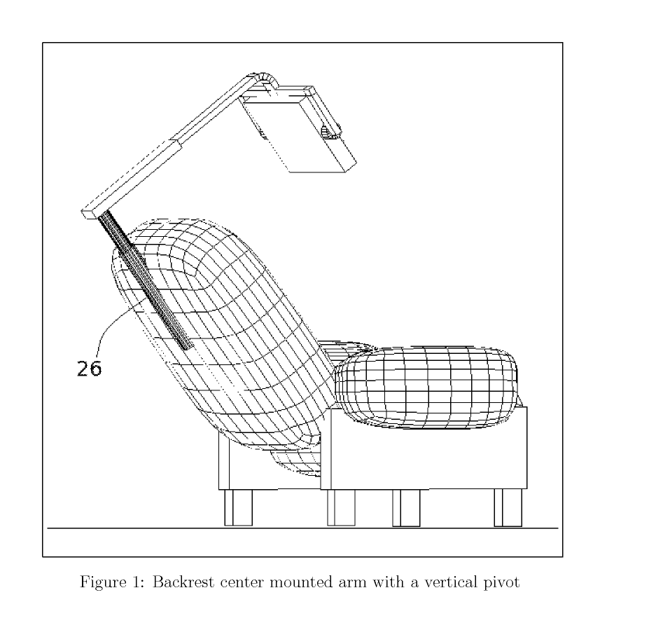

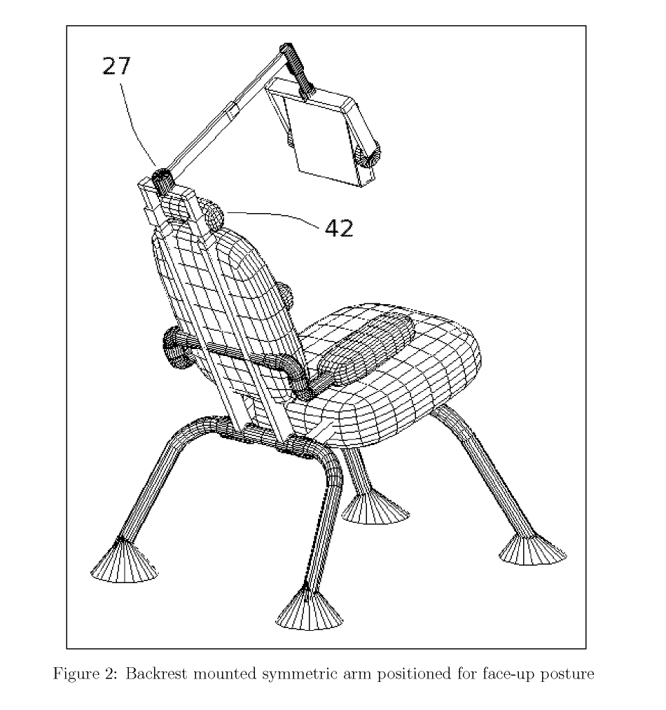

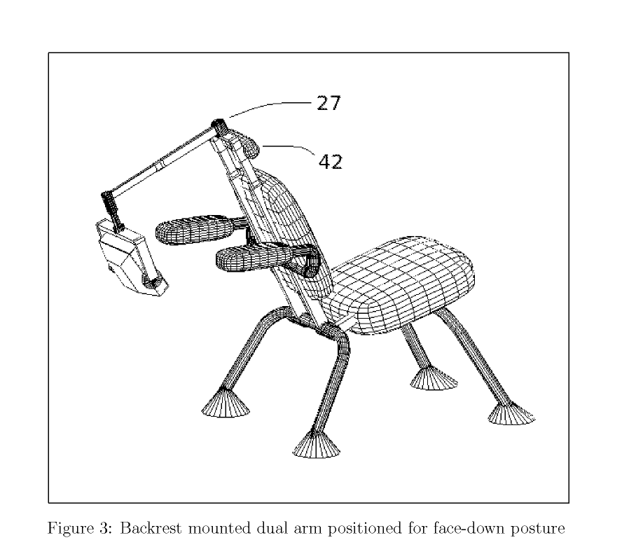

The arm itself can be realized as a combination of rigid elements, pivots, and telescopic joints for adjusting the position of the monitor, or can be made from a flexible conduit (Claim 2). The means for keeping the arm in a stable position can be realized as pivots, rails, or plain joints to attach the arm to the couch, or a combination of a separate base support resting on the floor and appropriate joint members. In particular, the arm can be attached to the backrest of a couch (Claim 3). The means for changing the position in this case can include standard pivots supplied with fixation mechanisms. The elongated member specified in the claim can be made of a plurality of pivotably joined members, or from a flexible conduit. In another variant (Claim 4) the arm can be attached symmetrically to the back of the backrest. In one embodiment illustrated in FIG. 1, a vertical pivot 26 is placed at the symmetry axis of the backrest, enabling rotation of the arm around that axis. In another embodiment the backrest of the chair is used for both ventral and dorsal support, with the possibility of repositioning of the monitor arm between the two postures (FIGS. 2,3). An additional head support element 42 will serve as a neck support in the dorsally supported position and as a forehead support in the ventrally supported position. A sliding mechanism for positioning the head cushion 42 along the backrest axis is used to adjust the head support between the two postures. The posture of the human in the case of a ventral support will be sitting on the chair with the breast leaning against the backrest, and looking at the monitor over the top of the backrest. In this case the vertical pivot 27 is mounted on the top of the frame holding the head support. In both embodiments of FIG. 1 and FIGS. 2,3 the arm is configured to rotate the monitor over the top of the backrest.

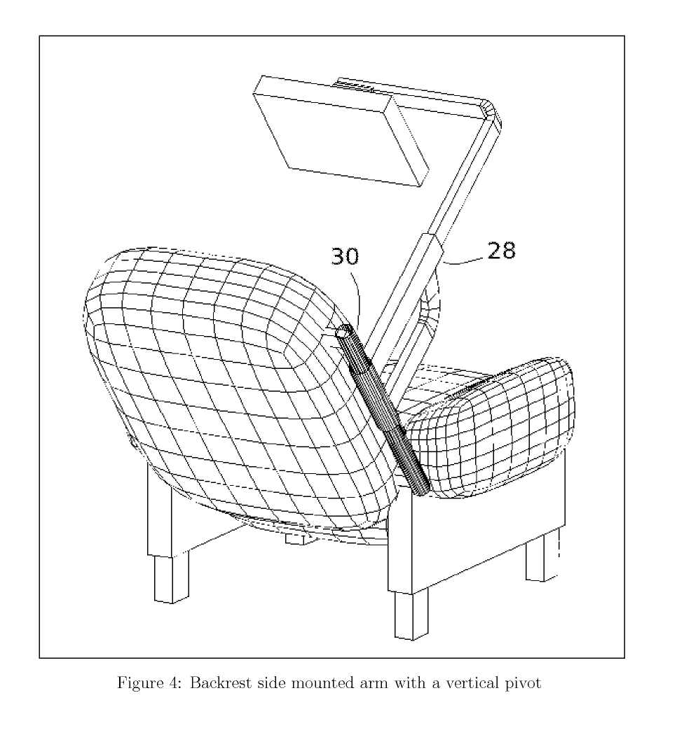

Another variant for the arm design (Claim 5) is to attach the arm to the side of the backrest, and provide the possibility of horizontal rotation of the arm to enable the human to enter or leave the couch. One possible embodiment of that is shown in FIG. 4, where the horizontal part of the arm 28 is pivotably joined to the axis 30 to enable rotations of the arm around the axis in the horizontal plane for exit/entry to/from the couch. In addition to that arm 28 can also be made to slide along the axis 30 to enable position adjustment of the monitor.

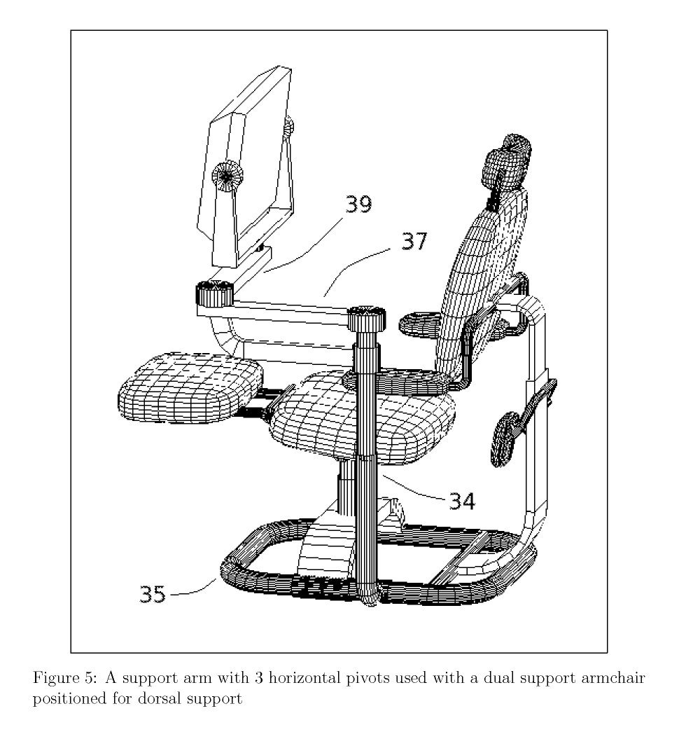

Another variant (Claim 10) is to attach the arm to the base frame of the couch. In this case the arm may consist of one vertical axis 34 and two horizontal support members, 37, 39, holding a rotating monitor frame. (FIG. 5). In this design the monitor can be relocated between the front and the back of the backrest by rotating the monitor in a horizontal plane around the backrest using the three vertical pivots joining the vertical axis 34, horizontal arms 37, 39 and the monitor frame. The means for adjusting the vertical position of the monitor can be implemented as telescopic extension mechanism built into the vertical support axis 34. The joint between the vertical base axis 34 and the base frame 35 can be made to slide along the base frame 35 so as to enable distance adjustment of the monitor from the backrest. Another alternative is to supply the main horizontal support arm 37 (FIG. 5) with a telescopic extension mechanism such as depicted by element 28 in FIG. 4.

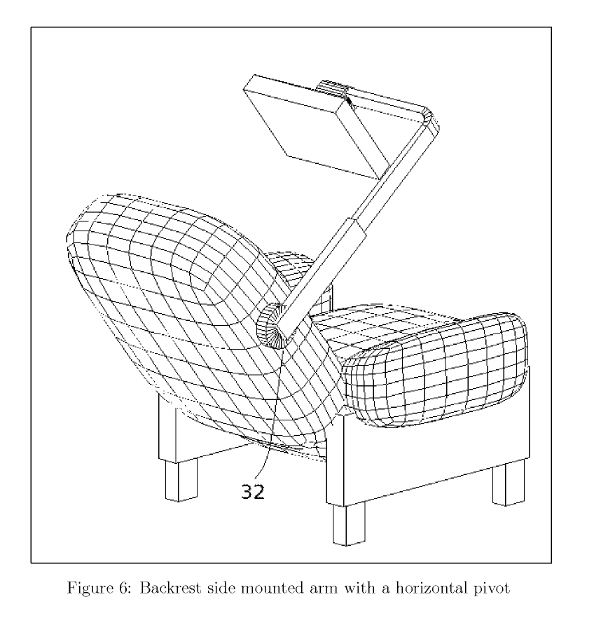

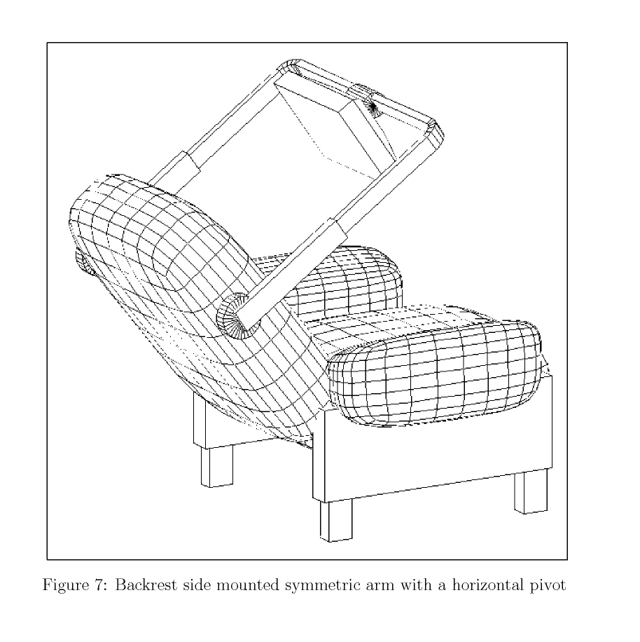

Another possibility is to enable rotation of the arm in the vertical plane (Claim 6) for both position adjustment and easy access to the couch. This can be accomplished by using a horizontal pivot mechanism 32 as shown in possible embodiments of the design in FIGS. 6, 7. A manual or an electric drives can be used rotate the arm. This design also provides the possibility of using the rotations of the arm in the vertical plane to move the monitor between the front and rear of the backrest of the chair, providing essentially the same functionality as described in the comments to the claim 4, but implemented using a side-mounted horizontal pivot as shown in FIGS. 6,7.

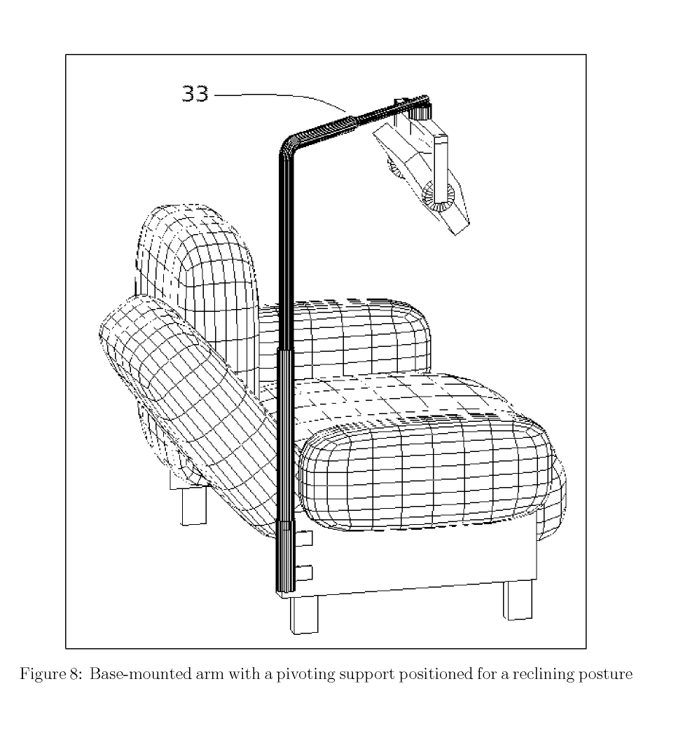

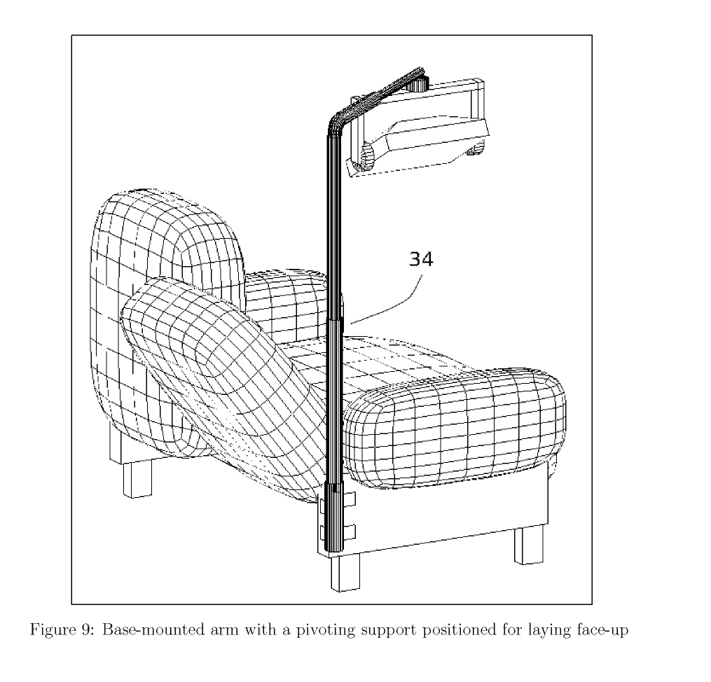

Mounting the arm on a non-moving parts of the couch, such as a base-frame (Claim 7) can provide a greater stability of the monitor with respect to possible shaking caused by a motion of a human body on the couch. A specific realization this design is disclosed in Claim 8 with one embodiment shown in FIGS. 8, 9. In this case the arm can be shaped as a long vertical supporting axial pole 34. Means for adjusting vertical position of the monitor can be implemented as a telescopic extension mechanism to enable height adjustments of the pole. The pole 34 (FIG. 8) can be bent at the top so as to position the monitor above the couch. This supporting pole can be fixed with respect to the base or can be pivotably joined to the latter as specified in Claim 9, thus enabling horizontal rotations of the arm. A telescopic joint 33 can be added to the horizontal section of the arm to enable horizontal positioning of the monitor. As can be seen from the figures, this design can be used for both reclining and lying down postures on a sofa.

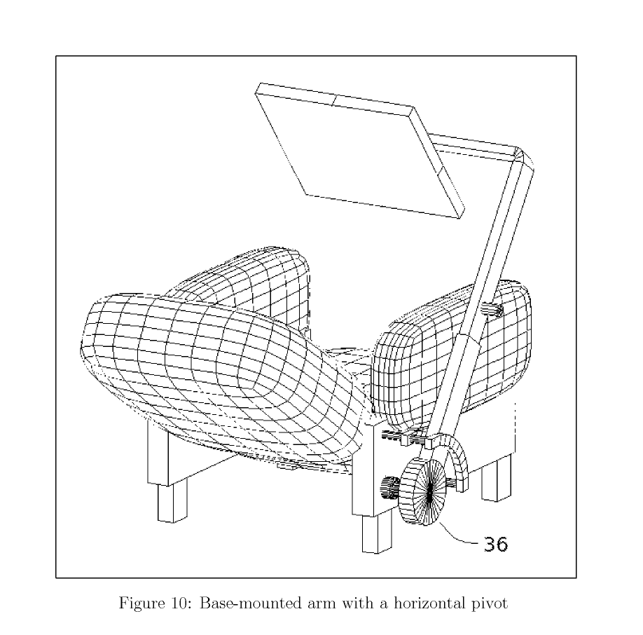

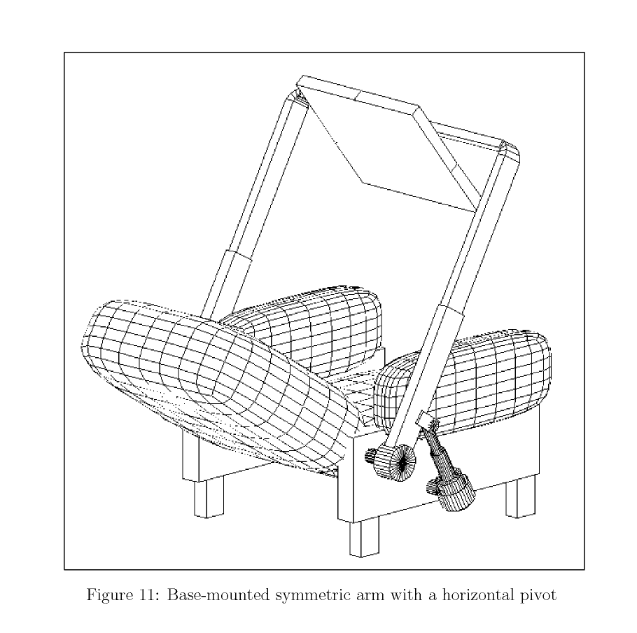

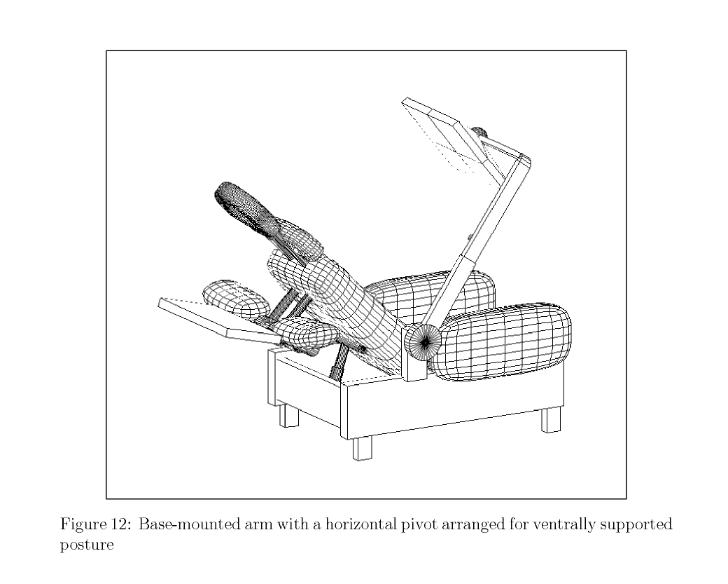

Claim 11 describes the design when the arm is mounted on the base of the couch and is made to rotate in a vertical plane by means of a horizontal pivoting mechanism 36, of electric or manual drive as is illustrated in FIGS. 10, 11, and 12. The latter embodiment also demonstrates the usage of the application in a couch which enables both dorsal and ventral support, in which case the arm will be moved between the front and the back of the backrest, as further discussed in the comments to Claim 13 below. Telescopic joints in the arm, or a sliding mechanism, can be used to control the distance between the human face and the monitor.

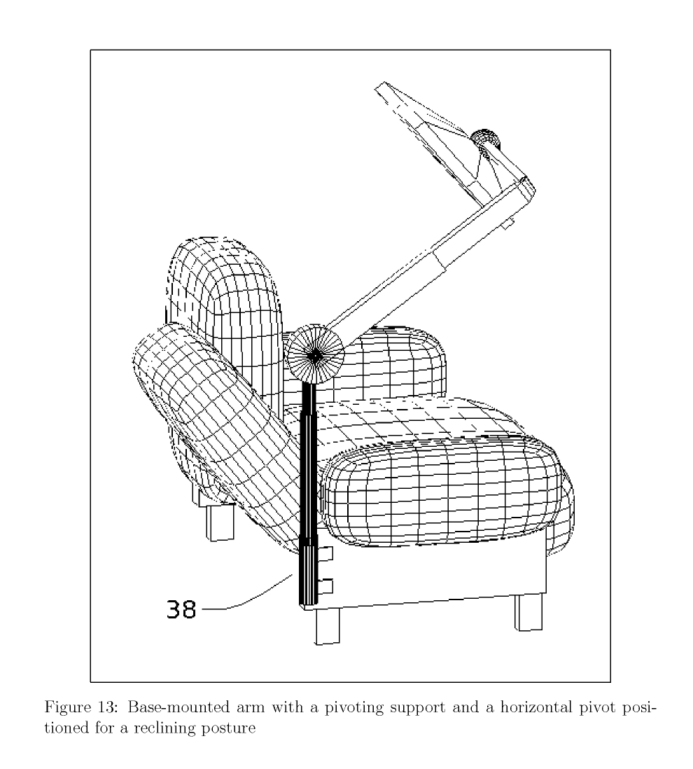

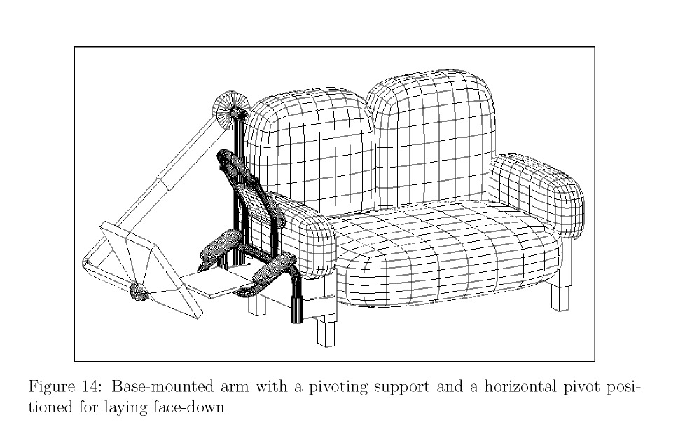

Claim 12 describes similar design extended with means of rotating the arm in the horizontal plane, which can be realized by additional vertical pivot 38 as shown in FIG. 13. The mechanisms of rotation can be of a manual type or using electric drives, such as rotary tables. This design also enables viewing the monitor while assuming postures with dorsal or ventral support. One particular embodiment illustrating the ventrally supported posture is shown in FIGS. 14,22, where the human will lean over the armrest and an additional stand for head and shoulders support is used to support the body in this posture as disclosed in Claim 18.

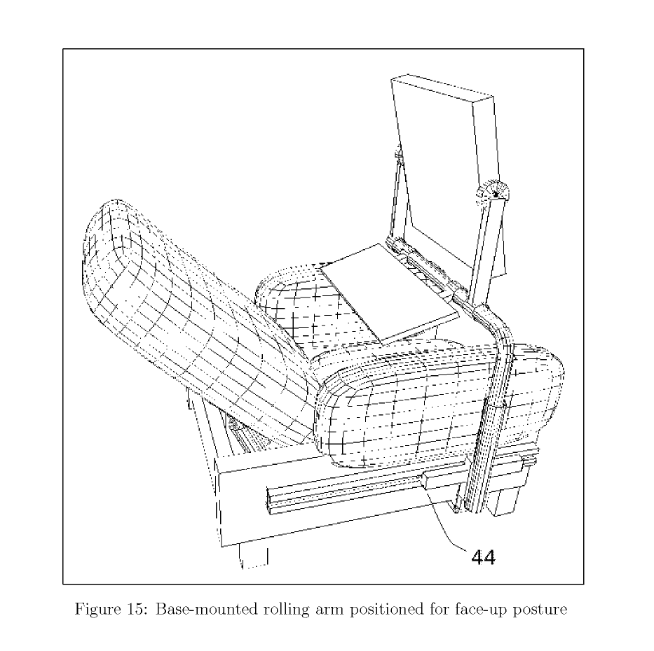

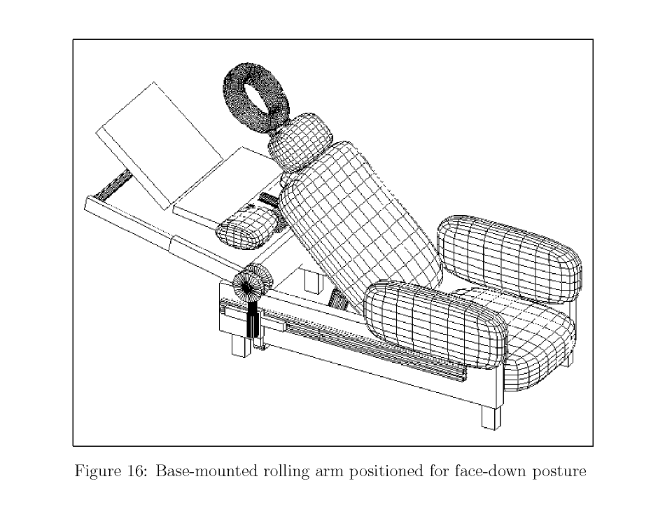

Another version of a base-mounted arm can be joined to the couch by means of a sliding or rolling mechanism which enables translational motion of the arm along the base of the couch (Claim 13). This can be implemented by any standard means, such as carriage and rails assembly 44 as shown in one embodiment in FIG. 15. This mechanism can also be used in combination with the design of claim 11 to facilitate repositioning of the monitor when changing between dorsally and ventrally supported postures as illustrated by one embodiment in FIG. 16. The height adjustment mechanism for the monitor specified in the claim can be implemented as a telescopic joint built into the monitor arm.

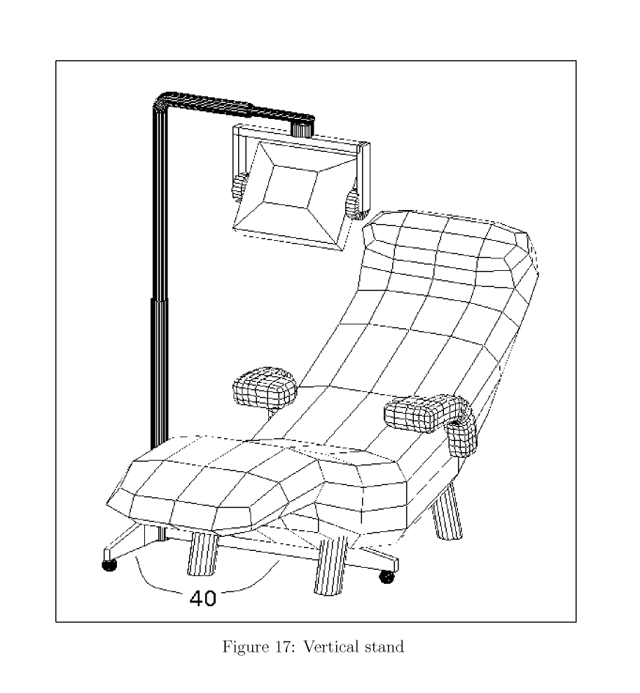

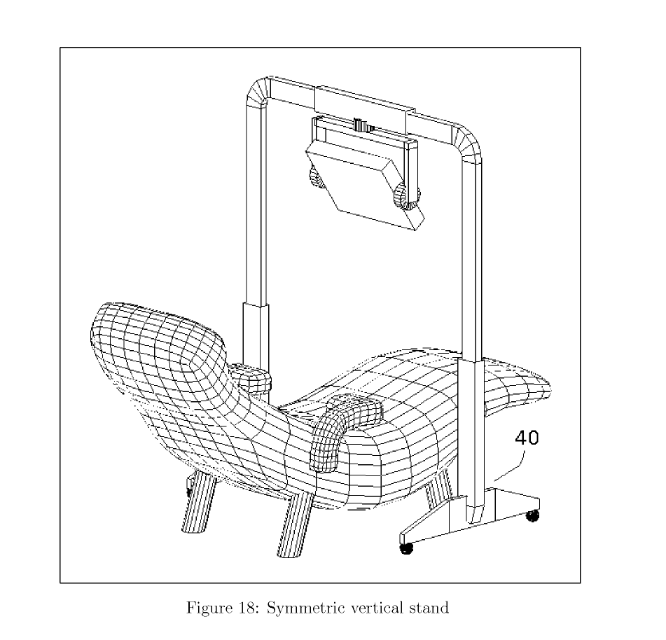

Claim 14 describes a generic design essentially similar to that covered by earlier claims but implemented as a detached monitor stand. In particular, Claim 15 describes the arrangement similar to that of Claim 8 but implemented as a stand detached from the couch. In the embodiments of FIGS. 17, 18 a specially designed support member, 40, is used to provide a stable support for the stand on the floor for different positions of the monitor above the couch.

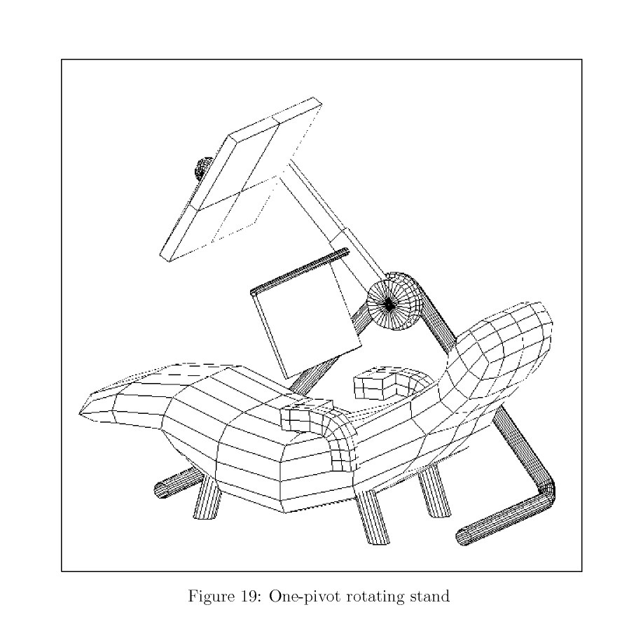

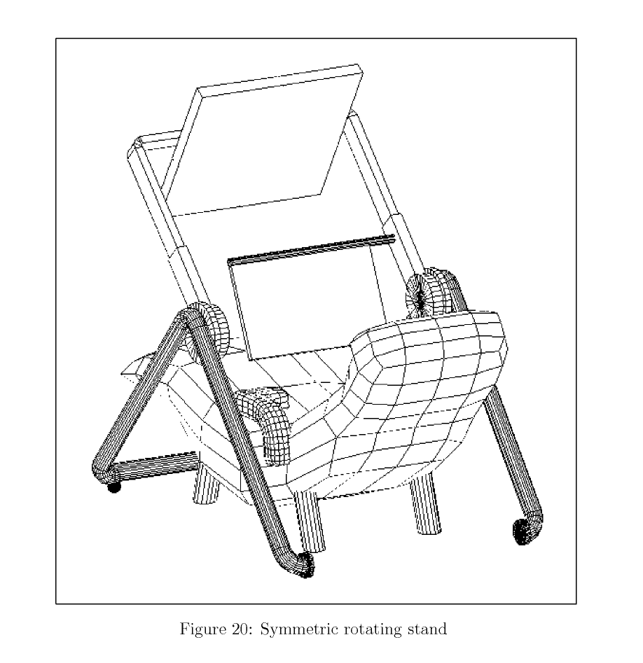

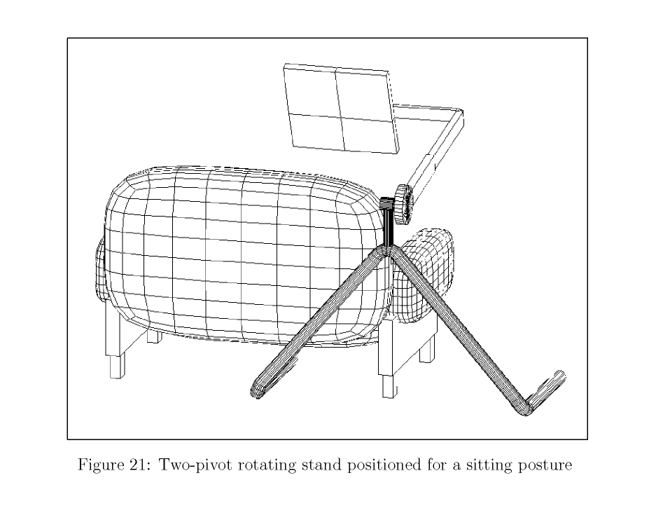

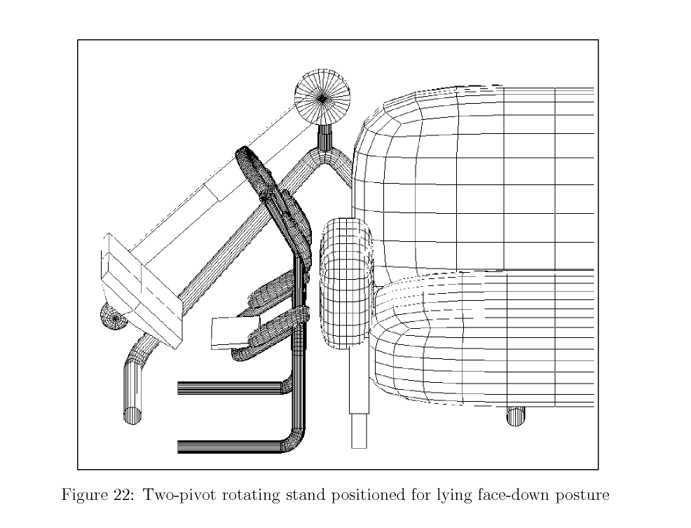

Claim 16 describes a monitor stand with the possibility of rotating the monitor holding arm in a vertical plane, which can be useful for large inclinations of the couch backrest, or for lying down positions. The rotation of the arm holding the monitor can be arranged using standard pivoting mechanism with a manual or electric drive, such as pneumatic gear, rotary tables and similar. Different embodiments of this design are shown in FIGS. 19, 20, 21, which illustrate the usage of the stand in a combination with standard reclining chairs and sofas, set for both sitting, reclining, and lying postures. Claim 16 also enables the design of the rotating stand with the possibility of bringing the monitor low enough so as to be viewed from the top, while assuming a ventral supported posture. One embodiment of this design is shown in FIG. 22 where a special head and shoulders support stand is used to provide the adequate ventral support.

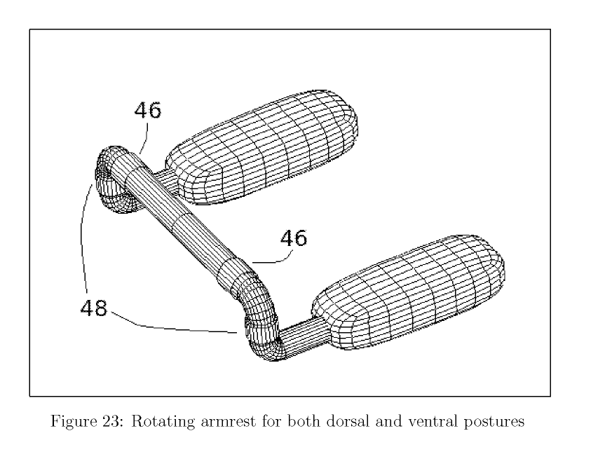

Claim 17 describes the design of a specially configured armrest which can be used in chairs that provide both dorsal and ventral support. The usage of this application is illustrated in FIGS. 2,3,5. In particular, FIG. 23 shows one possible embodiment of the design where there are two pairs of pivots, enabling rotations of the armrest in both horizontal and vertical planes. In practice, only one set of pivots will usually be needed. The particular arrangement shown in the figures will provide a higher position of the armrest in the ventrally supported posture than in a dorsally supported posture, if the armrest was rotated in a vertical plane, engaging horizontal pivots 46. In contrast, when vertical pivots 48 are engaged the position of the armrest on both sides of the backrest will be at the same level from the floor. It should be noted that a single horizontal pivot 46 located at the centrally on the armrest will also be sufficient.

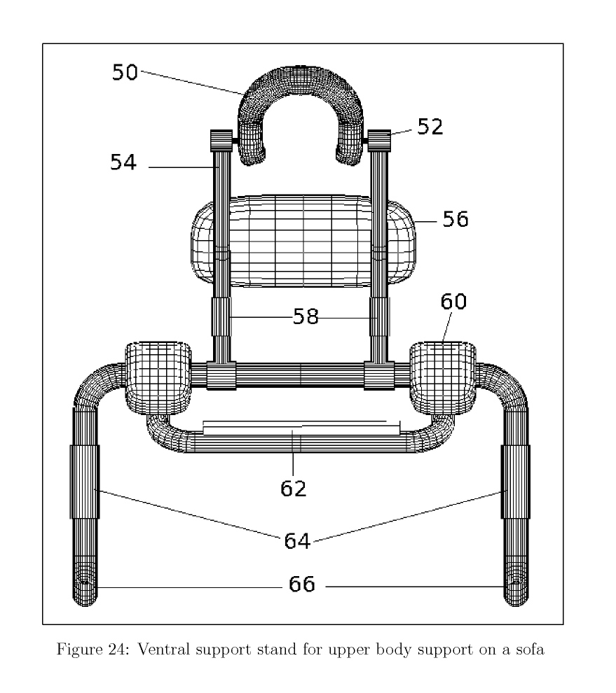

A special upper body support will be needed in combination with the monitor support arm when assuming a resting posture on a sofa with the monitor close to the floor level and the face turned down (Claim 18, FIGS. 24, 22, 14). Claim 19 describes the design where this body support is implemented as a stand resting on the floor (FIG. 22), while Claim 20 describes the same body support attached to the couch (FIG. 14). The means for joining the support members to the couch can be any suitable joints as shown in FIG. 14. The structural members of the body support apparatus comprise elements 50-66 described in Sec.2.

When relocating the monitor between the front and the rear of the backrest using rotations in the vertical plane the monitor will wind up in an upside-down position. In this case another rotation by 180° in the plane of the screen will be necessary, or a vertical flipping of the display image implemented in software.

The computer unit can be positioned anywhere close to the base of the monitor arm so as to minimize the length of the monitor extension cable.

The monitor arm should have a provision for running a monitor extension cable inside as well as the power cable. It is natural to use electric drives for pivots and telescopic joints.

A wireless keyboard and mouse would be best to use with this application. The positioning of the keyboard panel was not discussed here, since there are many standard means available for this purpose. For instance, the keyboard holding panel can be attached to the monitor holding arm. In many cases, a simple cushion placed on the body can be used to support the keyboard.

1. A monitor support apparatus for holding and positioning a computer monitor for comfortable viewing by a human resting on an article of furniture equipped with a backrest and supplied with a head support, and said monitor support apparatus comprising:
(a) a mechanical arm arranged to hold the monitor in front of the face of the human at a distance of approximately human arms length from the face, when the head of the human is resting on the head support so that the neck muscles are completely relaxed, and with the orientation of the monitor such that the line of sight from the eyes of the human to the monitor is approximately normal to both the plane of the screen of the monitor and the coronal plane of the head for at least two different angles between an imaginary vector pointing vertically upward and an imaginary vector pointing from the eyes of the human toward the monitor wherein said angles differ by at least 45 degrees
(b) means for supporting said arm in a stable position
whereby the human can comfortably watch the monitor while assuming different postures with a head support.

2. The monitor support apparatus of claim 1 wherein said arm is made of a flexible conduit.

3. The monitor support apparatus of claim 1 wherein said means comprising a joint member for joining said arm to the backrest, and said arm comprising:
(a) an elongated member shaped so as to hold the monitor in front of the face of the human
(b) means for changing the position of said elongated member
whereby the monitor can be placed in front of the face of the human for different head inclinations, as well as moved to enable an easy access for the human to said article of furniture.

4. The monitor support apparatus of claim 3 wherein said means for changing the position of said elongated member comprising a pivot with an axis of rotation approximately aligned with the axis of symmetry of the backrest for enabling rotations of the monitor around the backrest.

5. The monitor support apparatus of claim 3 wherein said means for changing the position of said elongated member comprising:
(a) an axis joined to one side of the backrest of said article of furniture parallel to the axis of symmetry of the backrest
(b) a pivoting joint for joining said elongated member to said axis so as to enable limited rotation of said elongated member around said axis.

6. The monitor support apparatus of claim 3 wherein said means for changing the position of said elongated member comprising a pivot for enabling rotation of said elongated member in a vertical plane.

7. The monitor support apparatus of claim 1 wherein said means comprising a joint member for joining said arm to a non-moving part of the article of furniture, such as a base frame, which does not change it's position with respect to the floor for any postures of the human.

8. The monitor support apparatus of claim 7 wherein said arm comprising:
(a) an elongated member shaped so as to hold the monitor above the seat of said article of furniture
(b) means for adjusting vertical position of the monitor
(c) a pivot mechanism for joining the monitor to said elongated member and enabling rotation of the monitor so as to align it s orientation with the coronal plane of the head
whereby the monitor can be positioned in front of the face of the human for different postures and head inclinations.

9. The monitor support apparatus of claim 8, further including a pivot for enabling rotation of said elongated member in a horizontal plane.

10. The monitor support apparatus of claim 7, wherein said arm comprising:
(a) an elongated vertical support member supplied with a height adjustment mechanism joined to said base support member
(b) a first horizontal elongated member pivotably joined at one end to the top of said elongated vertical support member so as to enable rotation of said first horizontal elongated member in a horizontal plane
(c) a second horizontal elongated member pivotably joined at one end to another end of said first horizontal elongated member so as to enable rotation of said second horizontal elongated member in a horizontal plane with respect to said first horizontal elongated member
(d) a frame for holding the monitor supplied with a pivot mechanism and joined to another end of said second horizontal elongated member so as to enable rotation of said monitor in both horizontal and vertical planes with respect to said second horizontal elongated member.

11. The monitor support apparatus of claim 7 wherein said arm comprising:
(a) an elongated member shaped so as to hold the monitor in front of the human
(b) a horizontal pivot for enabling rotations of said elongated member in a vertical plane.

12. The monitor support apparatus of claim 11, further including a vertical pivot for enabling rotation of said elongated member in a horizontal plane.

13. The monitor support apparatus of claim 7 further including a translation mechanism attached to the article of furniture so as to enable translational motion of said arm along the non-moving part of the article of furniture, such as a base frame.

14. A monitor support apparatus of claim 1 wherein said means comprising:
(a) a base support member positioned on the floor
(b) means for joining said arm to said base support member.

15. The monitor support apparatus of claim 14 wherein said arm comprising:
(a) an elongated member shaped so as to hold the monitor above the article of furniture
(b) a height adjustment mechanism for changing the vertical position of the monitor
(c) a pivot mechanism for changing the orientation of the monitor.

16. The monitor support apparatus of claim 14 wherein said means comprise a pivot joint for rotating said arm in a vertical plane.

17. An arms support frame attached to the backrest of a chair provisioned for postures with both dorsal and ventral support by the backrest, and comprising:
(a) two elongated members joined to the backrest and shaped so as to provide support for the arms of a human resting in the chair
(b) a pivot mechanism for enabling rotation of said elongated members so as to reposition said members between the front and the rear of the backrest
whereby the human can use the same arms support elements for both ventrally supported and dorsally supported postures.

18. An upper body ventral support apparatus for supporting the upper body of a human resting in a face down posture on an article of furniture, such as a sofa, and leaning over the armrest of said article of furniture, while watching the computer monitor from above, and comprising:
(a) a head support member for providing support for head
(b) an upper chest support member for providing support for the upper chest part of the body
(c) an elbows and arms support member for providing support for elbows and arms
(d) means for holding a keyboard and a mouse
whereby a human can lay face down with the lower part of the body supported by a sofa and the upper part of the body comprising upper chest, elbows, arms, and the head, supported by said ventral support stand.

19. The upper body support apparatus of claim 18 further including a base support member positioned on the floor for providing stable support for said body support apparatus.

20. The upper body support apparatus of claim 18 further including means for joining said body support apparatus to the article of furniture for providing a stable support for said body support apparatus.
